(19) United States
(12) Patent Application Publication
(10) Pub. No.: US 2010/0250704 A1
(43) Pub. Date: Sep. 30, 2010

(54) PEER-TO-PEER CONTENT DISTRIBUTION WITH DIGITAL RIGHTS MANAGEMENT

(75) Inventor: Armin W. KITTEL, Centreville, VA (US)

Correspondence Address: VERIZON;PATENT MANAGEMENT GROUP, 1320 North Court House Road, 9th Floor, ARLINGTON, VA, 22201-2909, US

(73) Assignee: VERIZON PATENT AND LICENSING INC., Basking Ridge, NJ (US)

(21) Appl. No.: 12/411,592

(22) Filed: Mar. 26, 2009

(51) Int. Cl. H04L 9/32; G06F 21/00; G06F 15/16

(52) U.S. Cl. 709/219; 726/7

(57) ABSTRACT

A method for peer-to-peer sharing may be performed by one or more devices within a subscription multimedia network, such as a closed distribution network. The method includes broadcasting a content reference of digital content available on a peer device within the subscription multimedia network, the content reference including digital rights management restrictions for the digital content associated with the content reference. The method also includes receiving, from a requesting media client using the subscription multimedia network, a selection of the content reference; and obtaining credentials of the requesting media client. The method further includes determining whether the credentials are acceptable for receiving the digital content based on the digital rights management restrictions; and providing, to the requesting media client using the subscription multimedia network, a decryption key for the digital content if the credentials are acceptable.

### BACKGROUND INFORMATION

A digital rights management (DRM) system protects content by separating the content from the rights associated with the content. Examples of content may include digital books, videos, and music. Accordingly, examples of content publishers, or content providers, may include book publishers and music labels. The content publisher encrypts the content and creates a Rights Object (RO) for the encrypted content. The RO may include the policies associated with the content, e.g. the RO may include (1) details about the rights granted to the content user regarding use or “rendering” of the content and (2) the decryption key to decrypt the content. When the user renders the content on his device, such as an MP3 player or personal computer (PC), a “DRM agent” in the device ensures that the user can render the content only according to the policies specified in the RO. Thus, the DRM agent prevents unauthorized rendering. “Rendering” may include performing any function on DRM content, including playing, viewing, or copying.

In a client-server model, a client endpoint (e.g., a client application or a client device) may establish a network connection with a centralized server endpoint (e.g., a server application or a server device) to obtain resources. In a peer-to-peer (P2P) model, a peer endpoint may establish one or more network connections with one or more peer endpoints to either provide or obtain resources that are distributed over one or more peer endpoints. P2P content distribution has become a popular vehicle to circumvent DRM systems.

### BRIEF DESCRIPTION OF THE DRAWINGS

FIG. 1 depicts an exemplary network in which systems and/or methods described herein may be implemented;

FIG. 2 is a block diagram of exemplary components of a video client that may be used in the network of FIG. 1;

FIG. 3 is a block diagram of exemplary components of a device that may correspond to the backend server of FIG. 1;

FIG. 4A is a diagram of exemplary functional components of the content catalog server of FIG. 1;

FIG. 4B is a diagram of exemplary functional components of the digital rights server of FIG. 1;

FIG. 4C is a diagram of exemplary functional components of the media client of FIG. 1;

FIG. 4D is a diagram of exemplary functional components of the peer device of FIG. 1;

FIGS. 5A and 5B provide a process flow illustrating exemplary operations to conduct P2P sharing; and

FIG. 6 provides an exemplary P2P exchange capable of being performed by the devices of FIGS. 1-4D.

### DETAILED DESCRIPTION OF PREFERRED EMBODIMENTS

The following detailed description refers to the accompanying drawings. The same reference numbers in different drawings may identify the same or similar elements. Also, the following detailed description does not limit the invention.

Implementations described herein may enable peer-to-peer (P2P) file sharing over a closed content delivery channel that incorporates digital rights management (DRM) for shared content. Content may be stored at local peers and/or at network file stores supplied by a service provider of the closed content delivery channel. Participants may provide references to available content. The references may be stored, for example, in a catalog server supplied by a service provider of the closed content delivery channel or at the local peers. Use of shared content may be limited by DRM license keys tied to the closed content delivery channel. In one implementation, the closed content delivery channel may be implemented through a subscription multimedia service providing network access through local media clients.

As used herein, the term “media client” may refer to any media processing device that may receive and/or send multimedia content over a closed network, and may provide such multimedia content to an attached device (such as a television, computing device, or monitor). A “subscription multimedia service,” as used herein, may refer to television, telephone, networking and/or other multimedia services provided to customers over a closed distribution network, such as cable, optical fiber, satellite or virtual private networks. Also, as used herein, the terms “user,” “peer,” “subscriber,” and “customer” may refer interchangeably to a person who interacts with, orders, uploads, listens to, or plays a multimedia content over a subscription multimedia service. As used herein, the term “peer-to-peer (P2P) connection” may refer to a connection in which participating endpoints may function as both a client endpoint and/or a server endpoint.

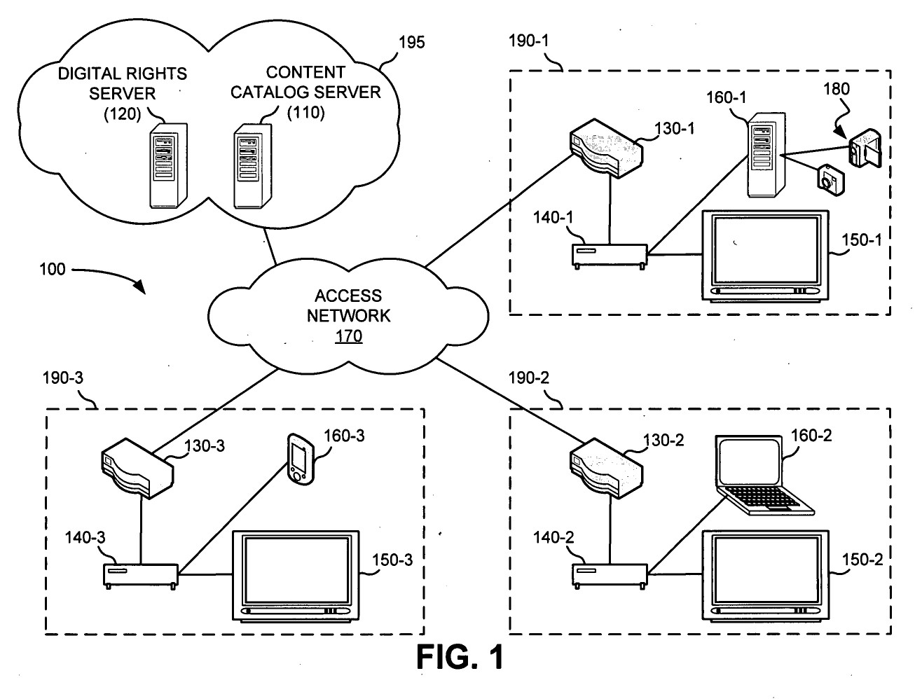

FIG. 1 is a diagram of an exemplary network 100 in which systems and/or methods described herein may be implemented. As illustrated, network 100 may include a content catalog server 110, a digital rights server 120, gateways 130-1, 130-2, 130-3 (herein referred to collectively as “gateways 130” and generically as “gateway 130”), media clients 140-1, 140-2, and 140-3 (herein referred to collectively as “video clients 140” and generically as “media client 140”), video display devices 150-1, 150-2, and 150-3 (herein referred to collectively as “video display devices 150” and generically as “video display device 150”), peer devices 160-1, 160-2, and 160-3 (herein referred to collectively as “peer devices 160” and generically as “peer device 160”), and an access network 170. Peer devices 160 may be locally networked to one or more peripheral devices 180.

Gateways 130, video clients 140, video display devices 150 and peer devices 160 may be located on a customer's premises, such as customer premises 190-1, 190-2, and 190-3 (herein referred to collectively and generically as “customer premises 190”). Content catalog server 110 and digital rights server 120 may be included within a provider network 195. Customer premises 190 may be connected via access network 170 to provider network 195. Components of network 100 may interconnect via wired and/or wireless connections.

For simplicity, one provider network (including one content catalog server 110 and one digital rights server 120), one access network 170, and three customer premises 190 have been illustrated in FIG. 1. In practice, there may be more servers, networks, and/or customer premises. Also, each of network 100 may contain additional, fewer, different or differently arranged devices than shown in FIG. 1. For example, content catalog server 110 and/or digital rights server 120 may include a virtual server, that is, the servers may include a group of servers that may logically appear as one server. Also, content catalog server 110 and/or digital rights server 120 may connect to one or more databases and other servers (not shown) to store and/or retrieve customer data and/or multimedia content. Additionally, each of customer premises 190 may include additional, fewer, different or differently arranged devices than shown in FIG. 1. Furthermore, in some instances, one or more of the components of network 100 may perform one or more functions described as being performed by another one or more of the components of network 100.

Content catalog server 110 may include servers or other network devices to collect and/or present listings of available resources to peer devices (e.g., peer devices 160). Users of peer devices may submit a file reference (such as a title and uniform resource locator (URL)) to content catalog server 110 that may be accessible to other peer devices that have access to subscriber network 170. Content catalog server 110 may also provide peer devices 160 with lists of users from/to which peers that are hosted on peer devices 160 can obtain/provide resources. In one implementation, content catalog server 110 may maintain state information about peers. The state information may be used to obtain lists of candidate peers that can provide the peers with resources (e.g., files, a period of game execution time, etc.). In some implementations, content catalog server 110 may provide the state information and the candidate lists to the peers.

Digital rights server 120 may include servers or other network devices to supervise DRM for transfer of content from one peer device (e.g., peer device 160-1) to another peer device (e.g., peer device 160-3) in a secure manner. Digital rights server 120 may implement control over, for example, the number of copies that may be made, who can access certain content, etc. Digital rights server 120 may, for example, restrict access based on DRM properties/protections assigned by a user who creates a file. In one implementation, digital rights server 120 may be a part of a network service provided by a subscription multimedia service provider.

Gateway 130 may include a network device that provides an interface from subscriber network 170 to media clients 140, peer devices 160, and other network connectivity devices (not shown). For example, when telecommunication services are provided to one of customer premises 190 via an optical fiber, gateway 130 may include an optical network terminal (ONT) that connects to the optical fiber. The ONT may convert between signals appropriate for video display device 150 and signals appropriate for transmission over optical fiber. For example, the ONT may include a coaxial cable connection that leads to media client 140. The ONT may also include an Ethernet output port that connects to a personal computer or a VoIP telephone and/or a standard telephone port for connecting to a standard telephone.

Gateway 130 may include one of a number of possible gateway devices, including a satellite antenna and receiver, a coaxial cable connection, an ONT, or a broadband access for Internet Protocol TV (IPTV). The satellite antenna and receiver may provide an interface for multimedia service broadcast from satellites. The coaxial cable connection may provide an interface for multimedia service connected to a customer via coaxial cables. The ONT may provide an interface for an optical fiber connection. The broadband IPTV access may generally include any device that provides broadband access over which multimedia service may be provided.

Media client 140 may include any device capable of receiving, transmitting and/or processing information to and/or from access network 170. In one implementation, media client 140 may be a closed device (e.g., includes a hardware/software configuration that is not accessible to the general public). Media client 140 may provide video signals to video display device 150 and/or peer device 160. Media client 140 may also include decoding and/or decryption capabilities and may further include a digital video recorder (DVR) (e.g., a hard drive). In one implementation, Media client 140 may include a set top box (STB). In another implementation, media client 140 may include a computer device, a cable card, a TV tuner card, a stationary device (e.g., a telephone or a computer), or a portable communication device (e.g., a mobile telephone or a PDA). In one implementation, media client 140 may be capable of providing interactive content to a user via video display device 150. Media client 140 may be capable of receiving input from a user via peripheral devices, such as peripheral device 180. Media client 140 may also be capable of sending data to and/or receiving data from content catalog server 110, digital rights server 120, other media clients 140, and/or peer devices 160. Media client 140 may further retrieve and/or store credentials that may be used to obtain access to content governed by DRM restrictions.

Video display device 150 may include any device capable of receiving and reproducing video signals. In one implementation, video display device 150 may include a television. In another implementation, video display device 150 may include, for example, a display of a stationary communication device (e.g., a computer monitor or a telephone), or a display of a portable communication device (e.g., a mobile telephone or a PDA). Video display device 150 may connect to media client 140 in a wired or wireless manner.

Peer device 160 may include a computing device such as, for example, a desktop computer, laptop computer, personal digital assistant (PDA), etc., used for general computing tasks. In some implementations, peer device 160 may be configured to receive and display television programming (e.g., IPTV). Computing devices 160 may also be used by users to access accounts with Internet service providers (ISPs) to send/receive content over access network 170.

Access network 170 may include a video signaling and distribution network and system that permit transfer of data between peer devices 160. Additionally, access network 170 may include, among other things, a firewall, filtering, a proxy, and/or network address translation mechanisms. Access network 170 may include, for example, a single network, such as a wide area network (WAN), a local area network (LAN), a telephone network (e.g., a public switched telephone network (PSTN) or a wireless network), the Internet, a satellite network, etc., or a combination of networks. Access network 170 may provide home customer premises 190 with multimedia content provided by peer devices 160 and/or content catalog server 110.

Peripheral devices 180 may include electronic devices that may be connected to a peer device 160. Peripheral devices 180 may include, for example, digital cameras, video recorders, personal digital assistants (PDAs), portable gaming devices, portable storage devices, or other electronic devices that may be capable of exchanging multimedia content.

In an exemplary implementation, a user of a peer device 160 (e.g., peer device 160-1) may select multimedia content to share in a P2P environment and may prepare the content with DRM properties/protections. A content reference to the DRM-protected multimedia content may be sent from peer device 160-1 to content catalog server 110. Another user of a peer device 160 (e.g., peer device 160-2) may select the content reference from content catalog server 110. Peer device 160-2 instruct the media client 140 associated with peer device 160-2 (e.g., media client 140-2) to provide credentials to digital rights server 120. Assuming the credentials are deemed valid, digital rights server 120 may provide a license key to decrypt the selected content. The selected content may then be sent/streamed from the originating peer device (e.g., peer device 160-1) and unscrambled by the receiving peer device (e.g., peer device 160-2).

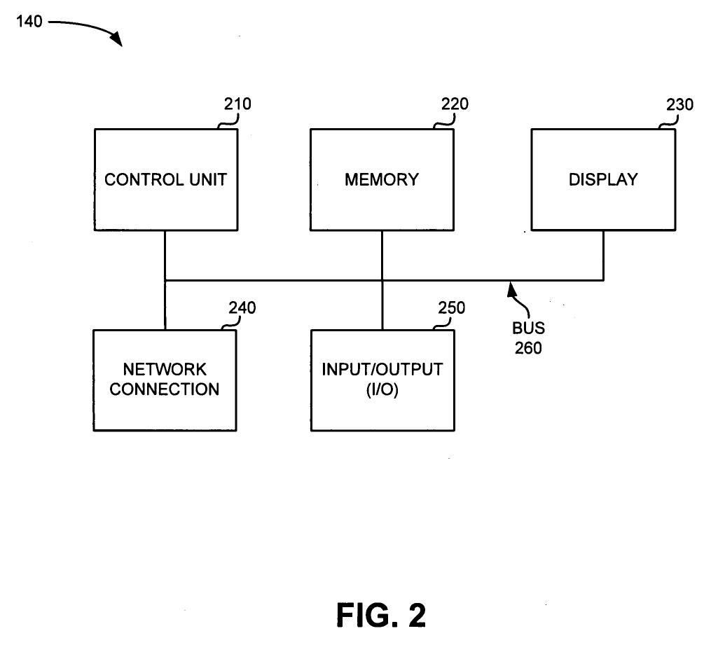

FIG. 2 is diagram illustrating exemplary components of media client 140. As shown, media client 140 may include a control unit 210, a memory 220, a display 230, a network connection 240, an input/output (I/O) component 250, and a bus 260.

Control unit 210 may include a processor, microprocessor, or another type of processing logic that interprets and executes instructions. Among other functions, control unit 210 may execute instructions to send credential information to another device, such as digital rights server 120. Control unit 210 may also receive information and/or instructions from other devices, such as content catalog server 110 and/or peer devices 160.

Memory 220 may include a dynamic or static storage device that may store information and instructions for execution by control unit 210. For example, memory 220 may include a storage component, such as a random access memory (RAM), a dynamic random access memory (DRAM), a static random access memory (SRAM), a synchronous dynamic random access memory (SDRAM), a ferroelectric random access memory (FRAM), a read only memory (ROM), a programmable read only memory (PROM), an erasable programmable read only memory (EPROM), an electrically erasable programmable read only memory (EEPROM), and/or a flash memory. In one implementation, memory 220 may store credential information and/or DRM license keys to facilitate P2P transactions.

Display 230 may include any component capable of providing visual information. For example, in one implementation, display 230 may be a light emitting diode (LED) or a liquid crystal display (LCD). In another implementation, display 230 may use another display technology, such as a dot matrix display, etc. Display 230 may display, for example, text (such as a time, a date or a channel selection), image, and/or video information. Display 230 may be an optional component.

Network connection 240 may include any transceiver-like mechanism that enables media client 140 to communicate with other devices and/or systems. For example, network connection 240 may include an Ethernet interface, an optical interface, a coaxial interface, a radio interface, or the like. Network connection 240 may allow for wired and/or wireless communication. Network connection 240 may be configured to connect media client 140 to a packet-based IP network.

Input/output devices 250 may generally include user input devices such as external buttons, and output devices, such as LED indicators. With input/output devices 250, a user may generally interact with media client 140. In some implementations, input/output devices 250 may be implemented via a remote control. A remote control may include a range of devices including function specific keys, number keys, and/or a full-text keypad. Bus 260 may provide an interface through which components of media client 140 can communicate with one another.

As will be described in detail below, media client 140 may perform certain operations relating to recording and communicating a history of viewer activities to a server, such as server devices 110. Media client 140 may perform these operations in response to control unit 210 executing software instructions contained in a computer-readable medium, such as memory 220. A computer-readable medium may be defined as a physical or logical memory device. A logical memory device may refer to memory space within a single, physical memory device or spread across multiple, physical memory devices.

The software instructions may be read into memory 220 from another computer-readable medium or from another device. The software instructions contained in memory 220 may cause control unit 210 to perform processes that will be described later. Alternatively, hardwired circuitry may be used in place of or in combination with software instructions to implement processes described herein. Thus, implementations described herein are not limited to any specific combination of hardware circuitry and software.

Although FIG. 2 illustrates exemplary components of media client 140, in other implementations, media client 140 may include fewer, additional, different and/or differently arranged components than those depicted in FIG. 2. In still other implementations, one or more components of media client 140 may perform one or more other tasks described as being performed by one or more other components of media client 140.

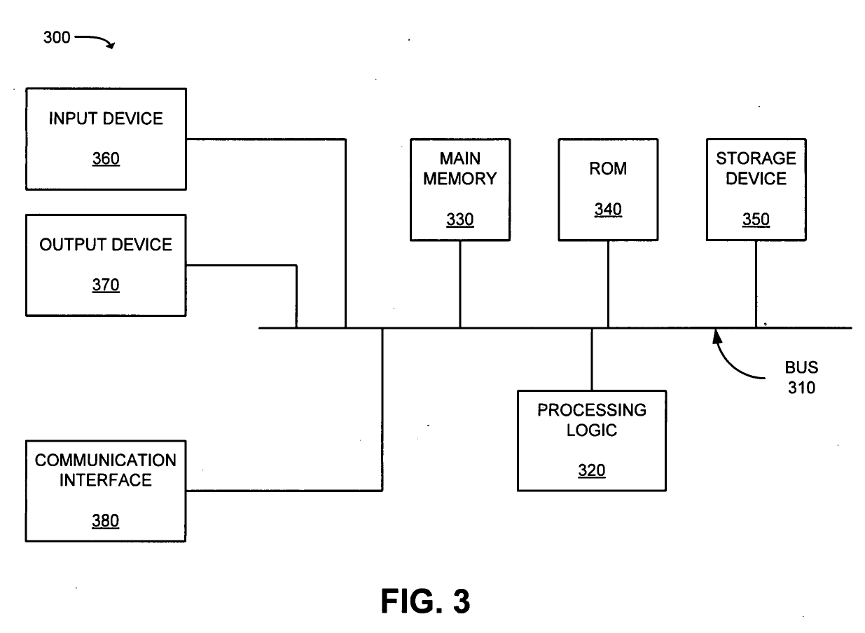

FIG. 3 is a diagram of exemplary components of a device 300 that may correspond to any of content catalog server 110, digital rights server 120, and/or peer devices 160. As illustrated, device 300 may include a bus 310, processing logic 320, a main memory 330, a read-only memory (ROM) 340, a storage device 350, an input device 360, an output device 370, and a communication interface 380.

Bus 310 may include a path that permits communication among the components of device 300. Processing logic 320 may include a processor, microprocessor, or other type of processing logic, such as an application-specific integrated circuit (ASIC), field-programmable gate array (FPGA), etc., that may interpret and execute instructions.

Main memory 330 may include a RAM or another type of dynamic storage device that stores information and instructions for execution by processing logic 320. ROM 340 may include a ROM device or another type of static storage device that may store static information and instructions for use by processing logic 320. Storage device 350 may include a magnetic and/or optical recording medium and its corresponding drive. In one implementation, storage device 350 may also include a database.

Input device 360 may include a mechanism that permits an operator to input information to device 300, such as a keyboard, a mouse, a pen, voice recognition and/or biometric mechanisms, a touch-screen interface, etc. Output device 370 may include a mechanism that outputs information to the operator, including a display, a printer, a speaker, etc. Communication interface 380 may include any transceiver-like mechanism that enables device 300 to communicate with other devices and/or systems, such as media client 140.

As will be described in detail below, device 300 may perform certain operations associated with providing P2P content delivery with DRM. Device 300 may perform these and other operations in response to processing logic 320 executing software instructions contained in a computer-readable medium, such as main memory 330.

The software instructions may be read into main memory 330 from another computer-readable medium, such as storage device 350, or from another device via communication interface 380. The software instructions contained in main memory 330 may cause processing logic 320 to perform processes that will be described later. Alternatively, hardwired circuitry may be used in place of, or in combination with, software instructions to implement processes consistent with exemplary implementations. Thus, implementations described herein are not limited to any specific combination of hardware circuitry and software.

Although FIG. 3 illustrates exemplary components of device 300, in other implementations, device 300 may include fewer, additional, different, and/or differently arranged components than those depicted in FIG. 3. In still other implementations, one or more components of device 300 may perform one or more other tasks described as being performed by one or more other components of device 300.

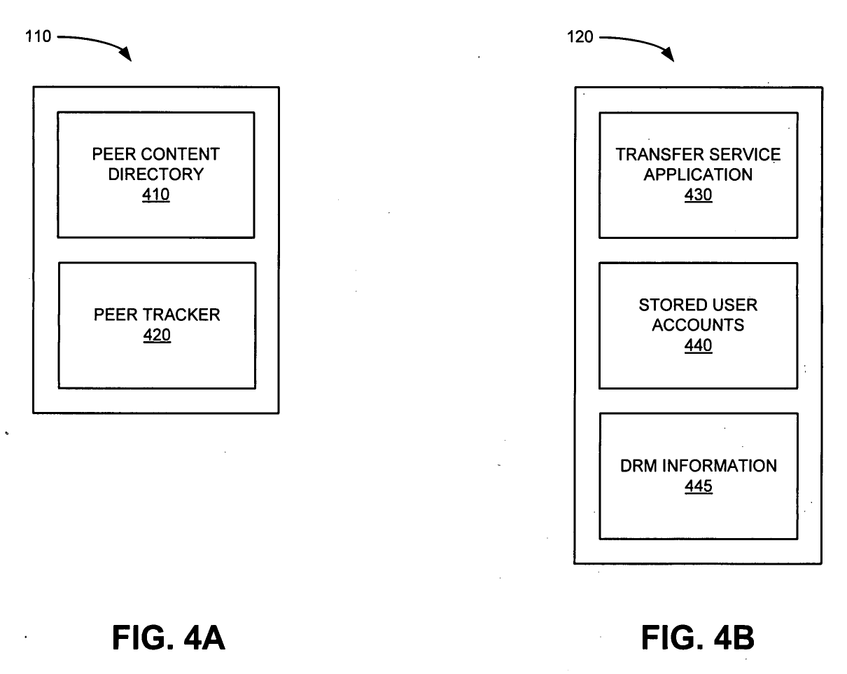

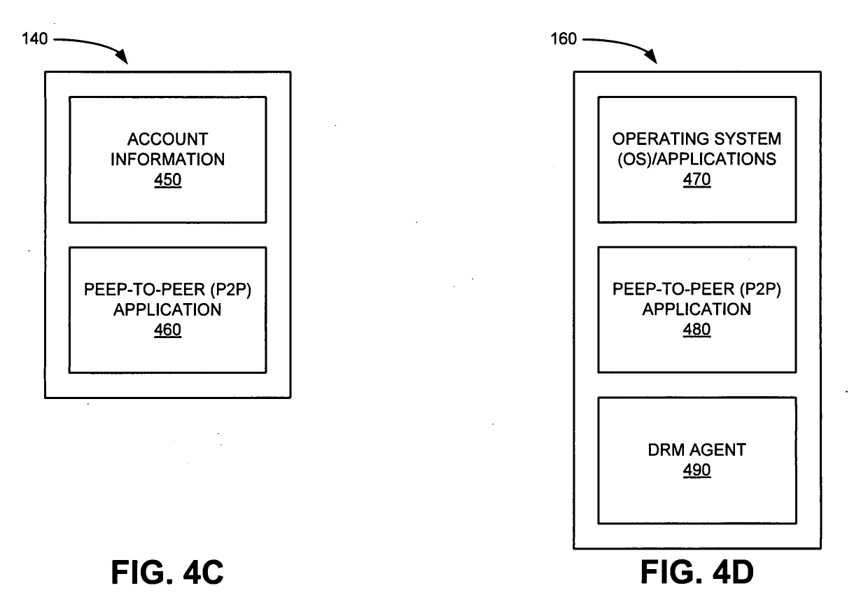

FIG. 4A provides a diagram of exemplary functional components of content catalog server 110. As shown, content catalog server 110 may include a peer content directory 410 and a peer tracker 420. Depending on the implementation, content catalog server 110 may include additional, fewer, different, or differently arranged components than those illustrated in FIG. 4A.

Peer content directory 410 may include content references of shared content and/or links to shared content that may be retrieved by media clients 140 and/or peer devices 160. In one implementation, peer content directory 410 may include a single file with a list of shared content that may be accessed by media clients 140 and/or peer devices 160. In another implementation, peer content directory 410 may be broadcast to media clients 140 as part of an existing directory, such as an electronic program guide for television content.

Peer tracker 420 may include hardware or a combination of hardware and software for tracking peer states (e.g., whether media clients 140 and/or peer devices 160 are currently connected to access network 170). Peer tracker 420 may also associate multiple peer devices that provide the same or similar content to provide subsets of candidate peers to a requesting peer device. In another implementation, peer tracker 420 may also track usage rates and/or statistics for P2P connections.

FIG. 4B provides a diagram of exemplary functional components of digital rights server 120. As shown, digital rights server 120 may include a include transfer service application 430, stored user accounts 440, and DRM information 445. Depending on the implementation, digital rights server 120 may include additional, fewer, different, or differently arranged components than those illustrated in FIG. 4B. For example, in some implementations, digital rights server 120 may incorporate features of DRM agent 490 described below with respect to peer device 160.

Transfer service application 430 may include hardware or a combination of hardware and software to allow digital rights server 120 to supervise DRM-based transfers from one media client 140/peer device 160 set (e.g., a source peer device) to another media client 140/peer device 160 (e.g., a requesting peer device), for example. In one implementation, transfer service application 430 may receive credentials from a media client associated with a user to determine if the user is authorized to receive requested digital content. In another implementation, transfer service application 430 may receive a unique identifier associated with a media client 140 and use the unique identifier to obtain account information for the user.

Stored user accounts 440 may include account information associated with media clients 140. For example, stored user accounts 440 may include a history of previously requested digital content associated with a media client 140. Stored user accounts 440 may also include subscription information associated with each media client. Subscription information may include, for example, a level of subscription service (basic, premium, promotional, etc.) associated with the user account, order histories, user preferences, etc.

DRM information 445 may include DRM security information used to control access to digital content, such as a rights object (RO) database, a rights issuer database, and/or a domain database. As used herein, “DRM security information” may refer to digital information that governs the rendering of content. For example, in one embodiment, “DRM security information” may include simply an RO database. DRM security information may be encrypted using a secret key, which makes the information only usable on peer devices 160 having the secret key.

The RO database may include the policies associated with DRM content. The RO database may include “stateful rights” for which digital rights server 120 explicitly maintains state information to correctly enforce permissions for rendering. Examples of state information may include the date/time of rendering or rendering count. A policy using a rendering count may be, for example, that a user cannot view a video more than twice. In this example, transfer service application 430 may keep a count of the number of renderings of the content and compare with DRM information 445 to restrict access beyond the rendering count limit.

The rights issuer database may include a private key and certificate associated with a publisher of DRM content. Digital rights server 120 may provide the appropriate private from the rights issuer database to key peer device 160, and peer device 160 may decrypt DRM content with the private key. In one implementation, digital rights server 120 may ensure the “integrity” of the DRM content (e.g., making sure the DRM content has not changed) using the appropriate certificate from the rights issuer database. The domain database may include information indicating what types of devices, such as peer devices 160, may be allowed to render DRM content. Types of devices may include, for example, a personal computer, a mobile phone, or a PDA.

FIG. 4C provides a diagram of exemplary functional components of media client 140. As shown, media client 140 may include account information 450 and a P2P application 460. Depending on the implementation, media client 140 may include additional, fewer, different, or differently arranged components than those illustrated in FIG. 4C.

Account information 450 may include, for example, information for user accounts associated with a media client. In one implementation account information 250 may include a unique identification number and/or character string for the media client. In other implementations, account information may include other subscription information, such as account access rights, parental controls, etc. In still another implementation, account information 450 may include geographic information to help identify local peers for sharing digital content.

P2P application 460 may include hardware or a combination of hardware and software that enables media client 140 to establish P2P connections with other media clients 140 over access network 170. P2P application 460 may incorporate various transport and/or sharing protocols, such as BitTorrent™, FastTrack™, Direct Connect, peer-to-peer television (P2PTV), Peer Distributed Transfer Protocol (PDTP), etc. P2P application 460 may also include decryption capabilities to decrypt encrypted content provided, for example, from a source peer device. Depending on context, the term “peer,” as used herein, may refer to media client 140 that hosts P2P application 460 and/or peer device 160 that hosts P2P application 480.

FIG. 4D provides a diagram of exemplary functional components of peer device 160. As shown, peer device 160 may include an operating system (OS)/applications 470, a P2P application 480, and a DRM agent 490. Depending on the implementation, peer device 160 may include additional, fewer, different, or differently arranged components than those illustrated in FIG. 4D. For example, in some implementations, peer device 160 may incorporate features of transfer service application 430 and DRM information 445 described above with respect to digital rights server 120.

OS/applications 470 may include hardware or a combination of hardware and software for performing various support functions for other components of peer device 160 and may provide for different functionalities of peer device 160. For example, OS/applications 470 may provide a browser as well as interfaces between the browser and the components in FIG. 3 (e.g., communication interface 380). In yet another example, OS/applications 470 may provide a Transmission Control Protocol (TCP)/Internet Protocol (IP) stack to support communication applications, such as P2P application 480.

P2P application 480 may include hardware or a combination of hardware and software for requesting and receiving a list of candidate peers devices from content catalog server 110, providing content to other peer devices 160, and/or obtaining content from other peer devices 160. In some implementations, P2P application 480 may include some or all of the features of P2P application 460. P2P application 480 may also include decryption capabilities to decrypt encrypted content provided, for example, from a media client 140. In other implementations, P2P application 480 may be an optional component.

DRM agent 490 may access security information from digital rights server 120 to provide content or retrieve content over access network 170. For example, DRM agent 490 may access the rights object database, the rights issuer database, and/or the domain database in DRM information 445. DRM agent 490 may use P2P application 480 to help coordinate the transfer of DRM security information and DRM content from one peer device 160 to another, such as from peer device 160-1 (acting as a source device) to peer device 160-2 (acting as a target device). DRM content may include, for example, music, images, video, and/or electronic books.

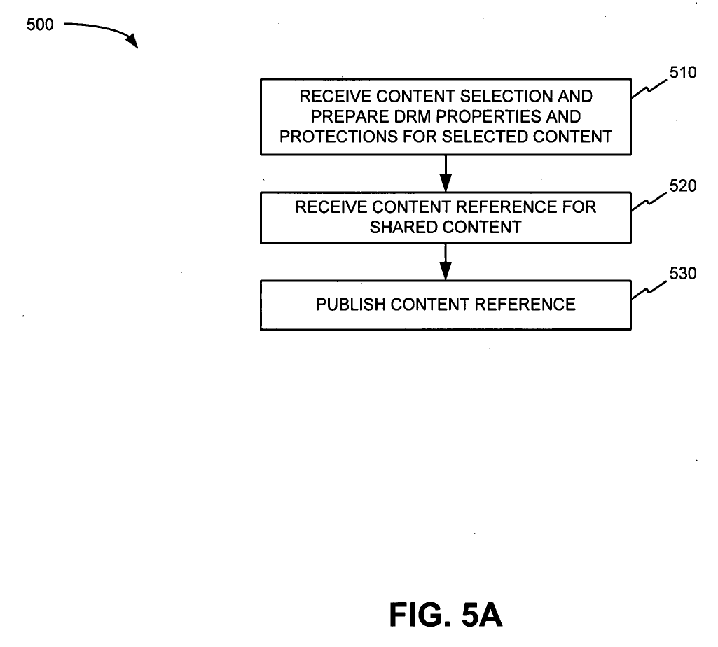

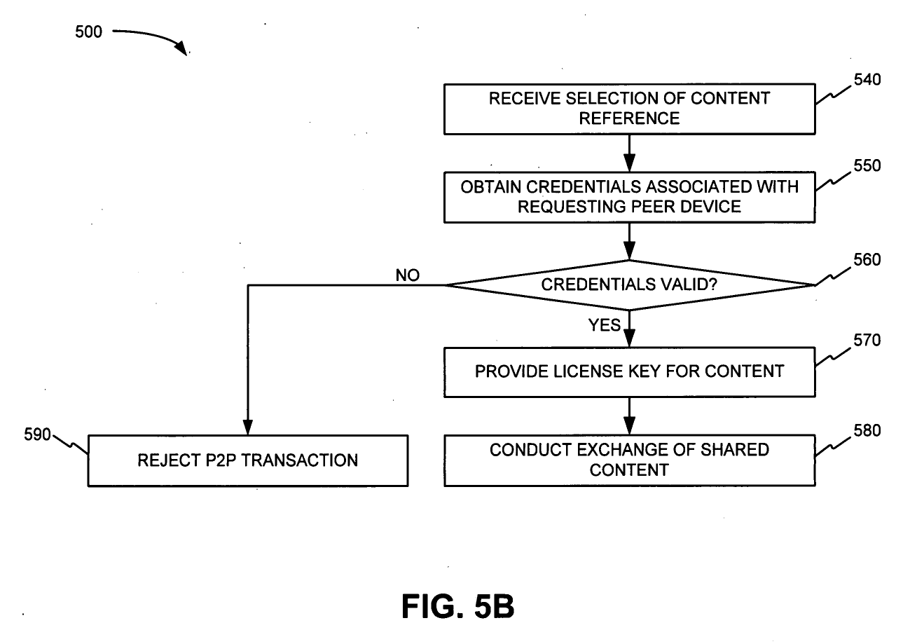

FIGS. 5A and 5B provide a process flow 500 illustrating exemplary operations to conduct P2P sharing. FIG. 5A includes exemplary operations to make content available for P2P sharing, and FIG. 5B includes exemplary operations to access shared P2P content. The operations may be performed by one or more servers associated with a subscription multimedia service, such as content catalog server 110 and digital rights server 120. In some implementations, certain operations may be performed by one or more video clients 140 and/or peer devices 160.

Process 500 may begin with receiving a selection for digital content to share and preparing DRM properties and protections for the selected content (block 510). For example, a user may select digital content to share and define a series of restrictions and/or encryption levels for the digital content. The content may be encrypted locally (e.g., at peer device 160 and/or media client 140) or at a server associated with a service provider, such as server 120. A DRM envelope (or rights object) may be created that includes DRM properties and protections for the digital content. Policies associated with the content may include, for example, details about the rights granted to the content user regarding use or rendering of the content and the decryption key to decrypt the content. In one implementation, the DRM envelope may include a default profile that corresponds to one of a number of categories. For example, DRM rights may be associated with particular television subscription packages, such that access to the digital content may be limited to subscribers of certain premium channels.

A content reference for the shared content may be received (block 520). For example, content catalog server 110 may receive a content reference for digital content that includes the DRM envelope. In one implementation, the content reference may be prepared by a peer device 160 and forwarded via media client 140 to content catalog server 110. If not previously obtained or created by digital rights server 120, information from the DRM envelope may also be forwarded to digital rights server 120.

The content reference may be published (block 530). For example, content catalog server 110 may make available a listing of the content reference to other subscribers. In one implementation, content catalog server 110 may incorporate the content reference with listings for other content (e.g., P2P and non-P2P), such as video-on-demand offerings. The published content reference may be selected by a user of media client 140, for example, as a conventional channel selection from a set-top box or television. In another implementation, the list of the content references may be viewed and selected using peer device 160 in communication with media client 140. In another exemplary implementation, the list of the content references may be viewed via a Web browser connected to, for example, media client 140.

Referring to FIG. 5B, a selection of the content reference may be received (block 540), and credentials associated with a requesting peer device may be obtained (block 550). For example, content catalog server 110 may receive a selection of the referenced content from media client 140. In one implementation, the selection request may include a unique identifier for media client 140 that allows media client 140 to be associated with a particular subscriber account. Content catalog server 110 and/or digital rights server 120 may use the unique identifier to determine credentials for the media client 140 and the associated peer device 160. The credentials may be based on, for example, subscriber account information, such as account history (e.g., records of previous downloads) or subscription levels (e.g., premium package subscriptions).

It may be determined if the credentials are valid (block 560). For example, digital rights server 120 may evaluate distribution limitations defined in the DRM envelope for the content reference and compare the distribution limitations to information from the subscriber account. For example, digital rights server 120 may determine whether the media client 140 associated with the subscriber has previously downloaded content related to the selected content reference. If the number of downloads available to a single subscriber are limited and that limit has been reached by the subscriber, digital rights server 120 may determine that the credentials of the media client 140 are invalid.

If the credentials are determined to be valid (block 560—YES), a license key for the requested content may be provided (block 570) and an exchange of shared content may be conducted (block 580). For example, digital rights server 120 may provide, to media client 140, a license key for the selected content reference. Media client 140 may then request and begin to receive the shared content from the source peer device 160.

If the credential are determined not to be valid (block 560—NO), the P2P transaction may be rejected (block 590). For example, digital rights server 120 may send a message to the requesting media client 140 that access to the content associated with selected content reference is denied.

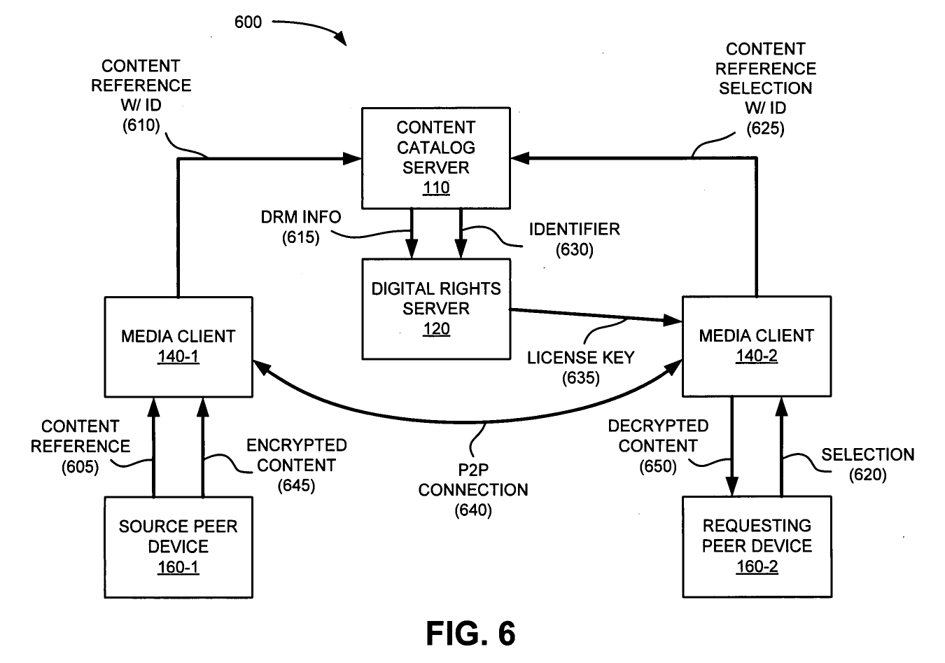

FIG. 6 provides an exemplary P2P exchange capable of being performed by the devices of FIGS. 1-4D. A user of source peer device 160-1 may choose to make particular digital content-a concert video for this example—available for sharing with peers over an access network. Using source peer device 160-1, the user may define DRM properties and protections for the concert video. To prevent unauthorized access to the content the selected file may be encrypted. In one implementation, peer device 160-1 may encrypt the content (i.e., concert video ) locally. In another implementation, the content may be sent to a media server (not shown) associated with the service provider that may encrypt the content and return the encrypted content to peer device 160-1 for later distribution. Assume for this example, that the DRM restrictions include viewing rights only for premium package subscribers on the access network. Source peer device 160-1 may send content reference 605 with a DRM envelope to media client 140-1. Content reference 605 may include a URL or equivalent identifier for later retrieval of the concert video.

Media client 140-1 may receive the content reference 605 and attach the media client's unique identifier. The content reference (including the DRM envelope) with the identifier 610 may be sent to the content catalog server 110 over the access network (not shown). The content catalog server 110 may add the title of the concert video to a catalog of content available for P2P sharing. The catalog may be available, for example, to all users of access network. Content catalog server 110 may also forward information 615 from the DRM envelope to digital rights server 120.

At some later time, a user of requesting peer device 160-2 may review the catalog of content available for P2P sharing and select the concert video previously made available from source peer device 160-1. Requesting peer device 160-2 may send the user's selection 620 to media client 140-2. Media client 140-2 may receive the selection 620 and attach the unique identifier of media client 140-2. The content reference selection with the identifier 625 may be sent to the content catalog server 110 over the access network (not shown). Content catalog server 110 may receive the content reference selection with the identifier 625. Content catalog server 110 may then pass on the identifier 630 for media client 140-2 to digital rights server 120.

Digital rights server 120 may use the identifier for media client 140-2 to confirm that media client 140-2 is associated with a premium subscription account and is therefore authorized to view the concert video. Upon confirming authorization, digital rights server 120 may provide license key 635 to media client 140-2 to enable media client 140-2 to decrypt/unscramble the concert video from source peer device 160-1. Media client 140-2 may then request a P2P connection 640 to receive the concert video from media client 140-1. Encrypted content 645 (e.g., the concert video with the DRM protection) may be sent from source peer device 160-1 to media client 140-1. Media client 140-1 may then pass the encrypted content to media client 140-2 using P2P connection 640. Media client 140-2 may decrypt concert video using the license key and provide decrypted content 650 to requesting peer device 160-2. The decrypted content may be provided, for example, in a format consistent with the DRM restrictions, such streaming video that cannot be copied by requesting peer device 160-2.

The illustration of FIG. 6 provides an exemplary arrangement for providing a P2P connection over a closed content delivery channel. Other arrangements may be used. For example, additional and/or alternative arrangements and techniques may be used to implement DRM controls.

Systems and/or methods described herein may be used to enable P2P sharing that incorporates digital media rights. A source media client may receive, from a source peer device, digital content and content references for the digital content, the content reference including digital rights management restrictions for the digital content associated with the content reference. A requesting media client may receive, from a requesting peer device, a request for digital content from the source peer device. An access network may provide a closed content distribution channel between the source media client and the requesting media client. A provider network may include one or more servers to receive, from the source media client, the content reference for the digital content and to receive, from the requesting media client, credentials of the receiving media client. The provider network may determine whether a user associated with the requesting media client is authorized to receive the digital content based on the credentials and the digital rights management restrictions. The provider network may then send, to the requesting media client, a decryption key for the digital content if the provider network determines the user associated with the requesting media client is authorized to receive the digital content. A P2P exchange may then be conducted between a requesting peer device associated with the requesting media client and a source peer device associated with the source media client.

Systems and/or methods described herein may reduce centralized storage demands for a provider network and optimize distribution by relying on source peers sources within closer geographic proximity to a requesting peer. Additionally, by tying DRM protections to a closed content delivery channel (e.g., connections between media clients over an access network), the probability of circumvention of DRM protections may be less that with DRM protections using open delivery channels (e.g., CDs, DVDs, or Internet delivery).

The foregoing description provides illustration and description, but is not intended to be exhaustive or to limit the implementations to the precise form disclosed. Modifications and variations are possible in light of the above teachings or may be acquired from practice of systems and/or methods disclosed herein.

Also, while series of blocks have been described with regard to the flowchart of FIG. 5, the order of the blocks may differ in other implementations. Further, non-dependent blocks may be performed in parallel.

It will be apparent that implementations, as described herein, may be implemented in many different forms of software, firmware, and hardware in the implementations illustrated in the figures. The actual software code or specialized control hardware used to implement embodiments described herein is not limiting of the invention. Thus, the operation and behavior of the embodiments were described without reference to the specific software code—it being understood that software and control hardware may be designed to implement the embodiments based on the description herein.

Further, certain implementations described herein may be implemented as “logic” that performs one or more functions. This logic may include hardware—such as a processor, microprocessor, an application specific integrated circuit or a field programmable gate array—or a combination of hardware and software.

It should be emphasized that the term “comprises/comprising” when used in this specification is taken to specify the presence of stated features, integers, steps, or components, but does not preclude the presence or addition of one or more other features, integers, steps, components, or groups thereof.

Even though particular combinations of features are recited in the claims and/or disclosed in the specification, these combinations are not intended to limit the disclosure of the invention. In fact, many of these features may be combined in ways not specifically recited in the claims and/or disclosed in the specification.

No element, act, or instruction used in the description of the present application should be construed as critical or essential to the invention unless explicitly described as such. Also, as used herein, the article “a” is intended to include one or more items. Where only one item is intended, the term “one” or similar language is used. Further, the phrase “based on,” as used herein is intended to mean “based, at least in part, on” unless explicitly stated otherwise.

What is claimed is:

1. A method performed by one or more devices within a subscription multimedia network, comprising:
broadcasting a content reference of digital content available on a peer device within the subscription multimedia network, the content reference including digital rights management restrictions for the digital content associated with the content reference;
receiving, from a requesting media client using the subscription multimedia network, a selection of the content reference;
obtaining credentials of the requesting media client;
determining whether the credentials are acceptable for receiving the digital content based on the digital rights management restrictions; and
providing, to the requesting media client using the subscription multimedia network, a decryption key for the digital content if the credentials are acceptable.

2. The method of claim 1, further comprising:
sending the digital content from a source media client to the requesting media client over a closed content delivery channel.

3. The method of claim 2, further comprising:
decrypting, at the requesting media client, the digital content sent from the source media client, and
sending the decrypted digital content to a display device.

4. The method of claim 1, where broadcasting the content reference of digital content comprises:
listing the content reference in an electronic catalog of content references; and
sending the catalog of content references to multiple media clients within the subscription multimedia network.

5. The method of claim 1, where the credentials of the requesting media client include:
a unique identifier for the media client.

6. The method of claim 5, where the credentials of the requesting media client further include:
account information for a user associated with the unique identifier.

7. The method of claim 1, further comprising:
sending the digital content from a source media client to a network server; and
sending the digital content from the network server to the requesting media client over a closed content delivery channel.

8. The method of claim 1, further comprising:
receiving, from a source media client, the content reference for the digital content.

9. The method of claim 8, further comprising:
sending, from a source peer device to the source media client, the content reference for the digital content; and
sending, from the source peer device to the source media client, the digital content.

10. One or more devices, comprising:
a memory to store instructions; and
a processor to execute the instructions to:
receive, from a source media client, a content reference for digital content that is available on a peer device, the content reference including digital rights management restrictions for the digital content associated with the content reference;
broadcast the content reference within a subscription multimedia network;
receive, from a requesting media client using the subscription multimedia network, a selection of the content reference;
obtain credentials of the requesting media client;
determine whether the credentials are acceptable for receiving the digital content based on the digital rights management restrictions; and
provide, to the requesting media client using the subscription multimedia network, a decryption key for the digital content if the credentials are acceptable.

11. The one or more devices of claim 10, where the processor further executes instructions to:
receive the digital content from a source media client, and
send the digital content to the requesting media client over a closed content delivery channel.

12. The one or more devices of claim 11, where the memory further stores the digital content from a source media client.

13. The one or more devices of claim 10, where, when executing the instructions to broadcast the content reference, the processor further is to execute the instructions to:
compile the content reference in list of content references; and
send the list of content references to multiple media clients within the subscription multimedia network.

14. The one or more devices of claim 10, where the credentials of the requesting media client include:
a unique identifier for the media client.

15. The one or more devices of claim 10, where, when executing the instructions to determine whether the credentials are acceptable for receiving the digital content based on the digital rights management restrictions, the processor is further to execute the instructions to:
retrieve account information for a user associated with the requesting media client, and
compare the account information with the digital rights management restrictions.

16. A system comprising:
a source media client to receive, from a source peer device, digital content and content references for the digital content, the content reference including digital rights management restrictions for the digital content associated with the content reference;
a requesting media client to receive, from a requesting peer device, a request for digital content from the source peer device;
a provider network including one or more servers to receive, from the source media client, the content reference for the digital content and to receive, from the requesting media client, credentials of the receiving media client; and
an access network including a closed content distribution channel between the source media client and the requesting media client,
where the provider network determines whether a user associated with the requesting media client is authorized to receive the digital content based on the credentials and the digital rights management restrictions, and
where the provider network sends, to the requesting media client, a decryption key for the digital content if the provider network determines the user associated with the requesting media client is authorized to receive the digital content.

17. The system of claim 16, where the source media client sends the digital content from to the requesting media client over the closed content delivery channel.

18. The method of claim 17, where the requesting media client receives the digital content over the closed content delivery channel and decrypts the digital content using the decryption key.

19. A system, comprising:
means for broadcasting a content reference of digital content available on a peer device within the subscription multimedia network, the content reference including digital rights management restrictions for the digital content associated with the content reference;
means for receiving, from a requesting media client using the subscription multimedia network, a selection of the content reference;
means for obtaining credentials of the requesting media client;
means for determining whether the credentials are acceptable for receiving the digital content based on the digital rights management restrictions; and
means for providing, to the requesting media client using the subscription multimedia network, a decryption key for the digital content if the credentials are acceptable.

20. The system of claim 19, further comprising:
means for sending the digital content from a source media client to the requesting media client over a closed content delivery channel.
